(19) United States
(12) Patent Application Publication
(10) Pub. No.: US 2011/0262161 A1
(43) Pub. Date: Oct. 27, 2011

(54) IMAGE FORMING APPARATUS

(75) Inventors: Tadashi Fukuda, Toride-shi (JP); Shinya Suzuki, Abiko-shi (JP)

(73) Assignee: CANON KABUSHIKI KAISHA, Tokyo (JP)

(21) Appl. No.: 13/090,468

(22) Filed: Apr. 20, 2011

(30) Foreign Application Priority Data
Apr. 26, 2010 (JP) 2010-100646

(51) Int. Cl. G03G 15/08

(52) U.S. Cl. 399/59

(57) ABSTRACT

An image forming apparatus includes a developing container for containing a developer including toner and a carrier; a feeding member for feeding the developer contained in the developing container; a drive control portion, capable of selectively executing at least operations in a first mode in which the developer is fed at a first feeding speed by the feeding member to form an image and a second mode in which the developer is fed at a second feeding speed, different from the first feeding speed, by the feeding member to form an image, for controlling the feeding speed of the developer by the feeding member depending on the operation in the mode to be executed; a toner content detection sensor for detecting toner content by using magnetic permeability of the developer contained in the developing container; and a voltage control portion for controlling a control voltage to be inputted into the toner content detection sensor. When the operation in the second mode is executed after the operation in the first mode is executed, the voltage control portion controls the control voltage in the second mode on the basis of a latest output value outputted by the toner content detection sensor in a preceding first mode.

### FIELD OF THE INVENTION AND RELATED ART

The present invention relates to an image forming apparatus of an electrophotographic type, such as a copying machine, a facsimile machine or a printer.

In a conventional image forming apparatus, a developing device using a two-component developer constituted by a toner and a carrier has been used. A clear image is stably obtained by keeping a toner content (a ratio of the toner to the carrier) within a proper range. When the toner content is out of the proper range, inconvenience as fog, carrier deposition, toner scattering and a decrease in density, on a white background portion are caused. Therefore, the toner content of the developer stirred and fed by a feeding member is detected by a toner content detecting means and then is controlled by adjusting timing of supply and exchange of the developer.

Further, the conventional image forming apparatus is operable in a plurality of image forming modes different in image forming speed in order to realize image quality movement and image formation on various media. In the plurality of image forming modes, an image forming speed is changed by changing the number of rotations of and process speed of a photosensitive drum. Further, a feeding speed of the feeding member provided in the developing device is also changed. A bulk density or the like of the developer detected depending on the feeding speed is changed, so that a toner content detection result of the toner content detecting means is changed.

Japanese Laid-Open Patent Application (JP-A) 2006-268034 discloses a constitution in which the toner content is detected at every feeding speed when the developer is replaced with a fresh developer, and the toner content of the developer is controlled by setting a detected value as a reference toner content. However, in the constitution of JP-A 2006-268034, the toner content can be detected with accuracy at an initial stage in which the developer is replaced. However, when the feeding speed is switched after the image formation is continuously and repeatedly effected, proper toner content control cannot be effected since an initially set reference toner content is used. For this reason, when the feeding speed is switched after the continuous image formation, an image density of an image to be outputted is fluctuated. That is, between the initial stage and after the continuous image formation, states of the developer such as flowability, bulk density and charge amount vary, so that magnetic permeability is changed even when the developer has the same toner content. For this reason, the toner content detection result of the toner content detecting means is changed, so that there is a need to change the reference toner content.

A quality observed by a user is the image density. For that reason, the change in image density when the feeding speed is switched must be avoided. The image density largely relates to the toner content and therefore it is necessary to stabilize the toner content in order to stabilize the image density.

Therefore, JP-A 2003-280355 discloses a constitution in which the toner content of the developer is detected at every feeding speed during warm-up when the image forming apparatus is turned on and then is controlled by setting a detected value as the reference toner content.

In the constitution of JP-A 2003-280335, there is less state in which the power is turned on from the initial stage to after the continuous image formation and therefore when the power is turned on at an intermediate stage, the reference toner content is newly set depending on a degree of the developer during the continuous image formation. For this reason, compared with the constitution of JP-A 2006-268034, in the constitution of JP-A 2003-280335, the fluctuation in image density is alleviated.

However, in the constitution of JP-A 2003-280335, a step of detecting the toner content for each feeding speed is required every correction of the toner content output value, so that a down time is increased.

### SUMMARY OF THE INVENTION

A principal object of the present invention is to provide an image forming apparatus which is designed to be driven at a plurality of image forming speeds and which is capable of suppressing a fluctuation in image density of an output image while suppressing a down time even when a feeding speed is switched.

According to an aspect of the present invention, there is provided an image forming apparatus comprising:

a developing container for containing a developer including toner and a carrier;

a feeding member for feeding the developer contained in the developing container;

a drive control portion, capable of selectively executing at least operations in a first mode in which the developer is fed at a first feeding speed by the feeding member to form an image and a second mode in which the developer is fed at a second feeding speed, different from the first feeding speed, by the feeding member to form an image, for controlling the feeding speed of the developer by the feeding member depending on the operation in the mode to be executed;

a toner content detection sensor for detecting toner content by using magnetic permeability of the developer contained in the developing container; and

a voltage control portion for controlling a control voltage to be inputted into the toner content detection sensor,

wherein when the operation in the second mode is executed after the operation in the first mode is executed, the voltage control portion controls the control voltage in the second mode on the basis of a latest output value outputted by the toner content detection sensor in a preceding first mode.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic sectional view of a developing device in First Embodiment.

FIG. 2 is a block diagram of a control portion for controlling an operation of the developing device and a toner content detecting means in First Embodiment.

FIG. 3 is a control flow chart in First Embodiment.

FIG. 4 is a schematic view of an image forming apparatus in First Embodiment.

FIG. 5 is a control flow chart in Third Embodiment.

### DESCRIPTION OF THE PREFERRED EMBODIMENTS

### First Embodiment

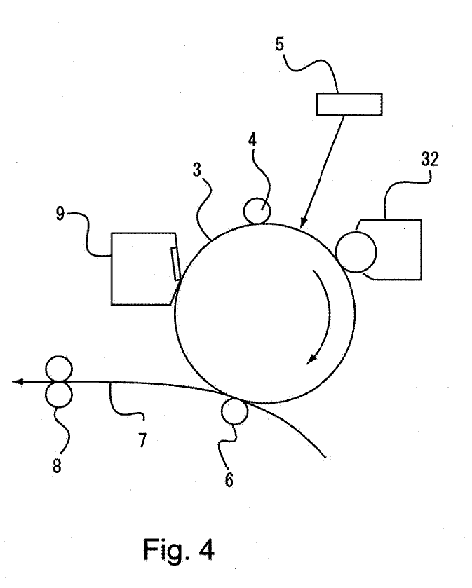

First Embodiment of an image forming apparatus according to the present invention will be described with reference to the drawings. FIG. 4 is a schematic view of an electrophotographic image forming apparatus in this embodiment. As shown in FIG. 4, the image forming apparatus includes a photosensitive drum (image bearing member) 3 provided rotatably and a primary charger 4 which electrically charges the photosensitive drum 3 uniformly. The charged photosensitive drum 3 is exposed to light such as laser light corresponding to image information by a light emitting device 5, so that an electrostatic latent image is formed. The electrostatic latent image is developed with a developer by a developing device 32, thus being visualized as a visible image (toner image). The toner image is transferred onto a sheet 7 by a transfer charger 6 and is fixed by a fixing device 8. Transfer residual toner remaining on the photosensitive drum 3 after the transfer is removed by a cleaning device 9.

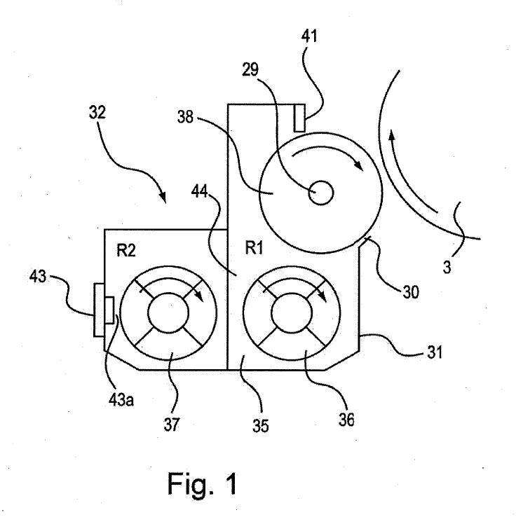

FIG. 1 is a schematic view of the developing device 32. As shown in FIG. 1, the developing device 32 includes a developing container 31 which is partitioned by a partition wall 44 into a developing chamber R1 which is a developer flow path and a stirring chamber R2. The developing container 31 contains the developer including a toner and a carrier. In the developing chamber R1 and the stirring chamber R2, stirring and feeding screws (feeding members) 36 and 37 are rotatably provided, respectively.

A developer feeding direction of the screw 36 in the developing chamber R1 and that of the screw 37 in the stirring chamber R2 are opposite from each other. The partition wall 44 is provided with an opening on each of a front side and a rear side in FIG. 1. Through these (two) openings, the developer 35 is transferred between the developing chamber R1 and the stirring chamber R2.

At an opening 30 of the developing chamber R1, a developing sleeve (developer carrying member) 38 to be rotated in an arrow direction at a peripheral speed Vb is provided. The developing sleeve 38 is disposed opposed to the photosensitive drum 3, to be rotated in an arrow direction at a peripheral speed Va, with a small gap. Inside the developing sleeve 38, the developer 35 is regulated in a proper layer thickness by a layer thickness regulating blade 41 provided at an upper end of the opening of the developer container 31 and thereafter is carried and fed to a developing region. In the developing region, a magnetic brush of the developer carried on the developing sleeve 38 is contacted to the photosensitive drum 3, so that the electrostatic latent image is developed.

A toner content detection sensor (toner content detecting means) 43 detects magnetic permeability of a developer 35 in a certain volume on a detecting surface 43a by using inductance, thus detecting the toner content (T/C (toner/carrier) ratio). The toner content detection sensor 43 is provided on a side surface of the stirring chamber R2 and in the neighborhood of the screw 37 but the present invention is not limited thereto. For example, the toner content detection sensor 43 may be provided at a position in which the developer having a layer thickness to the extent that the toner density can be detected is present on the detection surface 43a and flows during rotation of the screw 37.

### (Control of Developing Device 32 and Toner Content Detection Sensor 43)

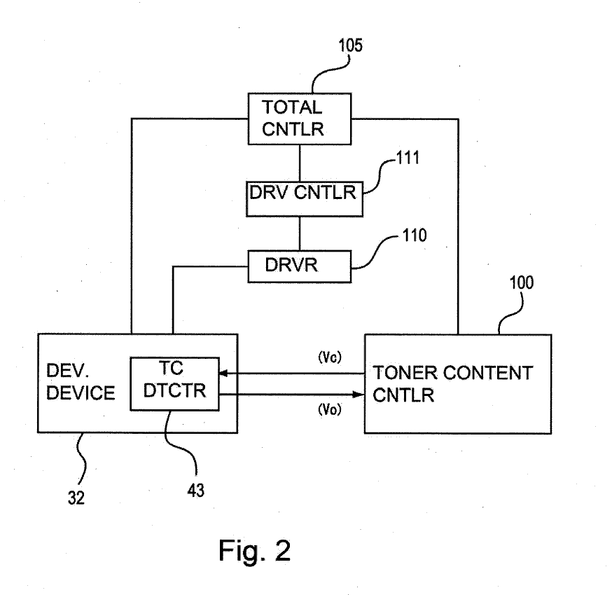

FIG. 2 is a block diagram of a control portion (controller) for controlling an operation of the developing device 32 and the toner content detection sensor 43. In FIG. 2, a total controller 105, a toner content controller 100 and a drive control 111 are constituted by a CPU and a memory. The toner content controller 100 inputs a control voltage Vc into the toner content detection sensor 43 and receives the magnetic permeability, as an output voltage Vo, detected by the toner content detection sensor 43. The output voltage Vo received by the toner content controller 100 is sent to the total controller 105. The total controller 105 controls a driving means (driver) 110 depending on an image forming mode, and the driver 110 drives the developing device 32. The image forming mode includes three modes consisting of an S1 speed mode, an S2 speed mode which is slower in speed than the S1 speed mode, and an S3 speed mode which is slower in speed than the S2 speed mode. The screw 37 can be driven at a plurality of feeding speeds including 450 rpm in the S1 speed mode, 300 rpm in the S2 speed mode and 150 rpm in the S3 speed mode. The image forming mode can be changed depending on a required image quality or the type of a transfer (recording) material. Thus, the total controller 105 effects speed switching control of the feeding speeds of the screws 36 and 37. The total controller 105 adjusts a set value of the control voltage Vc depending on the feeding speed. Further, the total controller 105 controls operations of toner supply and stop of the toner supply on the basis of the received output voltage Vo and controls the toner content in the developing container.

The toner content detection sensor 43 performs initial adjustment (initialize) of the control voltage Vc by using a developer with a known toner content. In the toner content detection sensor 43, a detection range is from 0 V to 5.0 V and the control voltage Vc is determined in a manner such that the output voltage Vo of 2.5 V is obtained by changing the control voltage Vc from Vc1, Vc2, . . . at multilevels. Incidentally, the toner content detection sensor 43 has a linear sensitivity characteristic in the detection range of 0 V to 5.0 V. Therefore, by performing linear interpolation of outputs Vo1, Vo2, . . . when the control voltage Vc is changed from Vc1, Vc2, . . . , the control voltage Vc at which the output voltage Vo is 2.5 V is determined.

The initial adjustment (initialize) is performed in the image forming mode in which the image forming speed is highest (hereinafter referred to as the S1 speed mode). In the S1 speed mode, the highest (fastest) image forming speed is obtained and therefore a use frequency is high. Further, in the S1 speed mode, the feeding speed is also highest, so that a time required for performing initial setting can be reduced.

The developer detected by the toner content detection sensor 43 is stirred by the screw 37. The bulk density or the like of the developer varies depending on the feeding speed of the screw 37, so that the output voltage Vo of the toner content detection sensor 43 is changed. Therefore, the control Vc is optimized at each feeding speed.

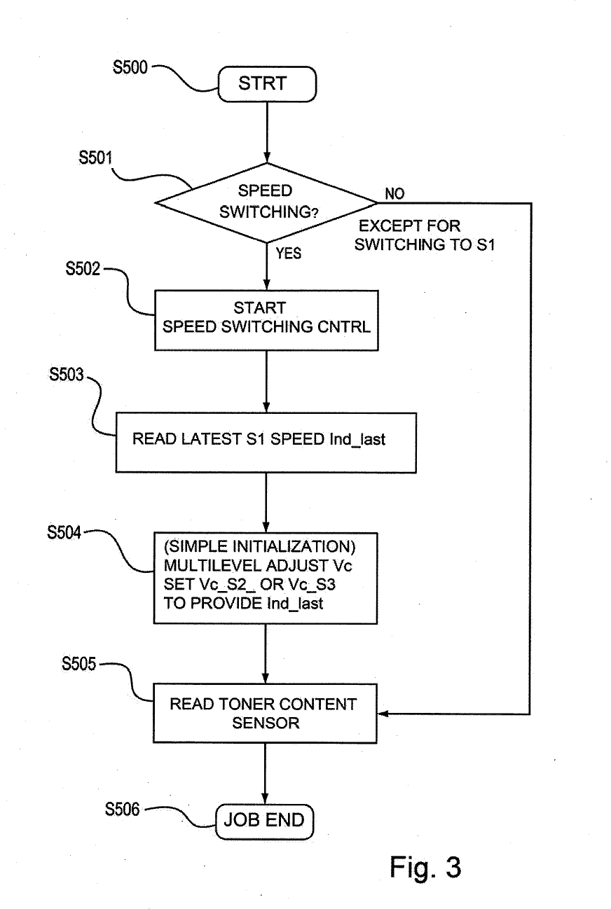

FIG. 3 is a control flow chart in this embodiment. As shown in FIG. 3, when an image forming job is inputted (START: S500), to total controller 105 judges whether or not the image forming mode in the inputted job is different from that in a preceding job and speed switching of the feeding speed should be effected (S501). The speed switching refers to speed changes from the S1 speed to the S2 speed, from the S1 speed to the S3 speed, from the S2 speed to the S3 speed and from the S3 speed to the S2 speed. Incidentally, the speed change to the S1 speed may also be regarded as the speed switching and thus the speed in this embodiment may be effected. However, the S1 speed mode is the mode in which the use frequency is high, and the use frequency is not high in the S2 speed mode and the S3 speed mode. Therefore, an erroneous detection of the toner content due to a deterioration of the developer less occurs in the S2 speed mode and the S3 speed mode. For this reason, in this embodiment, the control is not effected with respect to such a speed change.

In S501, when the total controller 105 judges that the speed switching should be performed, speed switching control is started (S502). First, the toner content controller 100 reads out an (latest) output voltage Ind_last (last recorded at the feeding speed before the speed switching) stored in the memory in the S1 speed mode immediately before the speed switching (S503). Then, a control voltage Vc_S2 after the speed switching is determined by changing the control voltage from Vc_S2_2, . . . at multilevels so that the output voltage Vo_S2 after the speed switching is equal to the read output voltage Ind_last (S504).

In S504, it is also possible to adjust the control voltage Vc_S2 by changing the control voltage at three or more levels but it takes much time for the change and reading of the control voltage Vc_S2. For that reason, the control voltage Vc_S2 is determined from the two levels of the control voltage. In order to determine the control voltage with accuracy from the two levels of the control voltage, the sensitivity characteristic of the toner content detection sensor 43 depending on a print number if obtained and stored in the memory as a database. The sensitivity characteristic of the toner content detection sensor 43 in this embodiment is linear. The output voltages Vo_S2_1 and Vo_S_2 when the control voltage Vc_S2 at the time of switching to the S2 speed mode is changed to Vc_S2_1 and Vc_S2_2 are detected. The sensitivity characteristic is linear and therefore a relationship between the control voltage and the output voltage is obtained by the linear interpolation and the control voltage providing a target output voltage Ind_last in the S2 speed mode is calculated. Hereinafter, the operation in S504 is referred to as simple initialize.

By using the determined Vc_S2, the toner content is detected by the toner content detection sensor 43 (S505) and the detected toner content is reflected in the toner supply or another control and thus the job is ended (S506).

By such control flow, when the image forming mode is switched, it is possible to suppress the fluctuation in image density of the images outputted before and after the switching. That is, when the speed switching of the feeding speed of the screw 37 is performed, the control voltage Vc after the speed switching is adjusted so that the output voltage Vo after the speed switching is equal to the output voltage Ind_last last received before the speed switching. For this reason, even when the speed switching is performed, the toner content can be detected with the same accuracy as that immediately before the speed switching. As a result, it is possible to decrease the fluctuation in image density between before the speed switching and after the speed switching.

The switching from the S2 speed mode to the S3 speed mode is performed so that the control voltage is adjusted with the aim of realizing the last value immediately before the S2 speed mode before the switching. Similarly, the switching from the S3 speed mode to the S2 speed mode is performed so that the control voltage is applied with the aim of realizing the last value immediately before the S3 speed mode before the switching. As a result, the fluctuation in image density between before the speed switching and after the speed switching can be decreased.

Further, the above-described control voltage adjustment can be performed during the image forming operation (from start of sheet conveyance after the speed switching until before the image formation), so that the down time is not caused.

Incidentally, in the case where the image forming apparatus is used for a long term in the same S1 speed mode, states of the developer such as those of the flowability, the bulk density and the charge amount are changed, so that the magnetic permeability is changed even when the developer having the same toner content is used. For this reason, the toner content detection result of the toner content detecting means is changed. Therefore, in the S2 speed mode, patch detection is performed to adjust the target output voltage Vo so that the image density of the output image is a proper image density. That is, in the case where the image density is decreased. Due to continuous use of the developer, the toner content detection sensor 43 cannot detected the toner content accurately. Therefore, in consideration of a detection error of the toner content detection sensor 43, the target output voltage Vo is adjusted to provide the proper image density.

The patch detection is performed such that a patch image formed on a sheet 7 by using the image forming means (the photosensitive drum 3, the primary charger 4, the light emitting element 5, the transfer charger 6, and the developing device 32) is subjected to density detection by a density detecting means (sensor) 10.

Incidentally, the S2 speed mode is the image forming mode which is used most frequently and therefore the operation is controlled with an intended toner content. In the S1 speed mode, the toner content is controlled more accurately, so that the image density is stabilized without causing the inconveniences on the image. Specifically, as described above, the toner amount for development is detected with predetermined timing. On the basis of the detection result, the toner content is adjusted and the image density is stabilized by using a means for changing a potential set value necessary for the development. Further, the charge amount and flowability of the developer vary depending on a status of use of the image forming apparatus and therefore the characteristic of the developer depending on the status of use is grasped as the database, so that the toner content control is effected. That is, in the S1 speed mode, the image is formed always at a stable density by using the control. In addition, the toner content is kept in a state suitable for the status of the image forming apparatus.

The S2 speed mode and the S3 speed mode are not assumed that the image forming apparatus is used for a long term in the same mode and therefore even when the image forming apparatus is continuously used in the same mode, deterioration of the developer does not occur and erroneous detection is not caused. For this reason, in the S2 speed mode and the S3 speed mode, the patch detection is not performed.

Thus, by performing the patch detection in view of the continuous use of the developer, even in any status of continuous use, the toner can be properly supplied and the image density of the output image can be kept in a proper range. As a result, the inconveniences such as the fog and carrier deposition on the white background portion, the toner scattering, and the decrease in image density are suppressed, so that a clear image can be obtained stably.

### (Comparative Experiment)

A comparative experiment in which this embodiment and a conventional example in which the toner content was detected at each feeding speed and a detected value was set as a reference toner content were compared was conducted. By using the image forming apparatuses in this embodiment and the comparative example, the image formation was repetitively effected in such a manner that the image was outputted on 1900 sheets in the S1 speed mode and then was outputted 100 sheets in the S2 speed mode. The image to be outputted was such that the inconveniences such as the density fluctuation and the fog on the white background portion were capable of being confirmed. Every 100 sheets, whether or not the inconveniences occurred on the output image was checked. At the same time, the value of the toner content detection sensor and an actual toner content were checked and also an amount of detection error of the toner content was checked. The amount of detection error of the toner content means a ratio of a difference between the actual toner content and the value of the toner content detection sensor to the actual toner content.

In the conventional example, the amount of detection error of the toner content exceeded 3.0% with respect to the images on the sheets after 20,000 sheets before and after the switching from the S2 speed mode to the S2 speed mode. For that reason, the fog on the white background portion occurred. Further, a reflection density on the image was also fluctuated by 0.3 and thus a degree of the density fluctuation was deteriorated. When the image was continuously outputted further, the amount of detection error of the toner content exceeded 4.0% on 23,000 sheets, so that the toner scattering occurred. In this embodiment, the toner scattering did not occur until the sheets after 52,000 sheets and the fog on the white background portion also did not occur. Further, the reflection density fluctuation did not exceed 0.3 and the amount of detection error of the toner content was within 0.8%.

### Second Embodiment

An image forming apparatus in Second Embodiment will be described. In this embodiment, with respect to the image forming apparatus, the simple initialize (S504) in First Embodiment is further simplified. In this embodiment, the sensitivity characteristic (the relationship between the control voltage Vc and the output voltage Vo) depending on the status of continuous use of the image forming apparatus at each feeding speed is stored as the database in the memory.

In the simple initialize in this embodiment, an output voltage Vo_S2 is read at a certain control voltage Vc_S2 and from this (one) measurement point (one control voltage), a certain control voltage Vc_S2 is set for the output voltage Ind_last in the S1 speed mode by making reference to the database.

As the control voltage Vc_S2 during the adjustment, a value changed from the control voltage Vc_S1 by a predetermined amount may be used or the control voltage may also be temporarily determined from the database. The database to which reference is made is integrated with respect to the number of sheets subjected to the image formation, the supplied toner amount, and the like and thus reference accuracy of the database is enhanced.

In the simple initialize in First Embodiment, the control voltage Vc_S2 was determined from the two control voltages. On the other hand, in the simple initialize in this embodiment, the control voltage Vc_S2 can be determined from only one control voltage by using the database as described above. For this reason, the simple initialize time can be reduced to ½ thereof. Further, a time from the setting of the control voltage Vc_S2 to the reading of the output voltage Vo_S2 can be reduced, so that a load on the CPU or the memory can be decreased. The load on the CPU is small and therefore another operation such as another control or the like using the toner content detection sensor 43 can be performed simultaneously.

### (Comparative Experiment)

Similarly as in First Embodiment, a comparative experiment in which this embodiment and a conventional example in which the toner content was detected at each feeding speed and a detected value was set as a reference toner content were compared was conducted.

In the conventional example, from 20,000 sheets, the fog and toner scattering on the white background portion attributable to the deterioration of the developer occurred. On the other hand, in this embodiment, even after 54,000 sheets, the fog and toner scattering on the white background portion did not occur.

Thus, also in this embodiment, similarly as in First Embodiment, the fluctuation in image density between the images outputted before and after the switching can be suppressed when the image forming mode is switched. Further, the toner can be properly supplied and the image density of the output image can be kept in a proper range. As a result, the inconveniences such as the fog and carrier deposition on the white background portion, the toner scattering, and the decrease in image density are suppressed, so that a clear image can be obtained stably. Further, the above-described adjustment of the control voltage can be performed from the start of conveyance of the sheets after the switching of the feeding speed until before the image formation, so that the down time is not caused.

### Third Embodiment

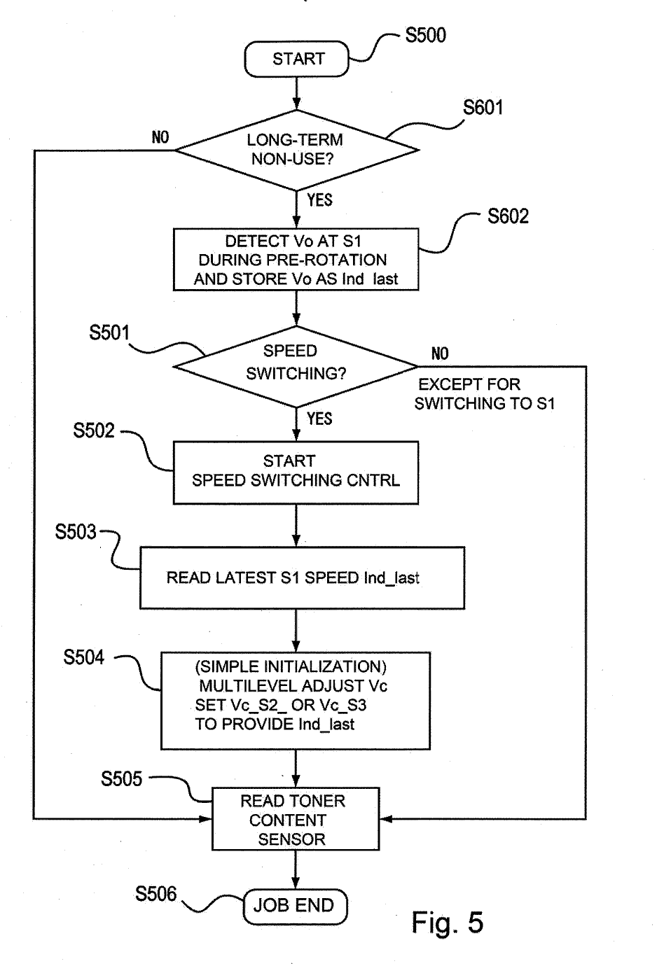

An image forming apparatus in this embodiment will be described with reference to FIG. 5. FIG. 5 is a control flow chart in this embodiment. As shown in FIG. 5, in the image forming apparatus, control steps (S601 and 5602) in the case of long term non-use are provided between S500 and S501 in the control flow in First Embodiment. The long term non-use includes, e.g., the case where the image forming apparatus is not used and left standing for a period (time) in which the charge amount of the developer is changed (e.g., a whole day and night). The total control portion 105 functions as a time detecting portion for detecting the time in which the image forming apparatus is not operated.

When the image forming job is inputted (START: S500), whether or not the image forming apparatus is left standing is judged from the time recorded by the total control portion 105 (S601). In this embodiment, a state in which the image forming apparatus is not used for 10 hours or more is regarded as a state of long term non-use.

In S601, in the case where the image forming apparatus is judged as being not in the state of long term non-use, a preparatory operation is not performed and then a flow of S505 is performed. In S601, in the case where the image forming apparatus is judged as being in the state of long term non-use (in the case where a job for switching the speed to the S2 speed at first time after the long term non-use), during a preparatory rotation operation, the output voltage Vo is detected at the feeding speed (S1 speed) before the long term non-use and at the control voltage Vc before the long term non-use. This is output voltage Vo is recorded as the output voltage Ind_last (S602). Then, the flow of S501 is effected.

Incidentally, in place of the control such that the detection of the toner content is performed during the preparatory rotation operation, the output voltage Ind_last may also be determined by using the database. This database includes data of non-use time and the characteristic of the toner content detection sensor 43. In this case, the non-use time is read in S601 and reference of the database is made, and then the output voltage Ind_last after the non-use is determined (S602).

As described above, in the case of the long term non-use, the output voltages Vo of the toner content detection sensor 43 before and after the long term non-use are different from each other and therefore correction of the output voltage is made depending on the long term non-use time. As a result, even when the output voltage Vo of the toner content detection sensor 43 is changed by the long term non-use, the toner content can be kept in a proper range.

That is, the output voltage Vo of the toner content detection sensor 43 is changed between the state of the developer when the image forming apparatus is frequently used and the state of the developer immediately after the non-use time of the image forming apparatus is long such as start of the day after weekends. There is a possibility that a first output voltage Vo after the image forming apparatus is not used for a long term (after long term non-use) is deviated from the output voltage Vo before the long term non-use. Further, when the reference to the output voltage before the long term non-use is made as the output voltage Ind_last immediately before the long term non-use, the status of continuous use of the developer by the long term non-use cannot be taken into consideration, so that the toner content cannot be accurately detected. Therefore, in this embodiment, the target output voltage Vo is adjusted so as to provide a proper image density by taking into consideration a detection error of the toner content detection sensor 43 attributable to the status of continuous use of the developer by the long term non-use. Particularly, when the speed switching is effected immediately after the long term non-use, the detection error occurs. In this embodiment, by taking such a detection error into consideration, it is possible to keep the toner content in the proper range.

### (Comparative Experiment)

A comparative experiment in this embodiment was conducted in the same manner as in First Embodiment. In First Embodiment it was possible to form the image with no occurrence of defective image until the sheets after 52,000 sheets. However, from the sheets after 46,000 sheets, degrees of the image density fluctuation and fog on the white background portion were somewhat deteriorated after the non-use time of 10 hours or more. Further, from the sheets after 54,000 sheets, when the feeding speed was changed to the S2 speed and the image was formed immediately after the image forming apparatus was left standing for 10 hours or more, the degrees of the image density fluctuation and fog on the white background portion were further deteriorated. On the other hand, in this embodiment, until the print number exceeded 74,000 sheets, the image density fluctuation and fog on the white background portion did not occur during periods including the long term non-use and the speed switching periods.

Incidentally, the control in the case of the long term non-use in this embodiment is also applicable to Second Embodiment. According to this embodiment, not only the effects in First Embodiment and Second Embodiment can be obtained but also it is possible to suppress the image density fluctuation of the images outputted before and after the speed switching even immediately after the long term non-use. Further, in conveniences such as the fog and carrier deposition on the white background portion, the toner scattering, and the decrease in image density are suppressed, so that a clear image can be stably obtained.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 100646/2010 filed Apr. 26, 2010, which is hereby incorporated by reference.

What is claimed is:

1. An image forming apparatus comprising:
a developing container for containing a developer including toner and a carrier;
a feeding member for feeding the developer contained in said developing container;
a drive control portion, capable of selectively executing at least operations in a first mode in which the developer is fed at a first feeding speed by said feeding member to form an image and a second mode in which the developer is fed at a second feeding speed, different from the first feeding speed, by said feeding member to form an image, for controlling the feeding speed of the developer by said feeding member depending on the operation in the mode to be executed;
a toner content detection sensor for detecting toner content by using magnetic permeability of the developer contained in said developing container; and
a voltage control portion for controlling a control voltage to be inputted into said toner content detection sensor,
wherein when the operation in the second mode is executed after the operation in the first mode is executed, said voltage control portion controls the control voltage in the second mode on the basis of a latest output value outputted by said toner content detection sensor in a preceding first mode.

2. An apparatus according to claim 1, wherein said voltage control portion controls the control voltage to be inputted into said toner content detection sensor so that an output value of said toner content detection sensor in the second mode is the latest output value detected in the first mode.

3. An apparatus according to claim 1, wherein when the operation in the second mode is executed after the operation in the first mode is executed, the control voltage is controlled during an image forming operation.

4. An apparatus according to claim 1, further comprising a time detecting portion for detecting a time in which the image formation is continuously stopped,
wherein when the time detected by said time detecting portion is longer than a predetermined time and subsequent image formation is effected in the second mode, said voltage control portion controls the control voltage to be inputted into said toner content detection sensor in the second mode on the basis of an output value of said toner content detection sensor obtained in a state in which said feeding member is driven at the first feeding speed before the image formation is effected.

5. An apparatus according to claim 1, wherein when the mode is switched from the first mode to the second mode, said voltage control portion determines the control voltage in the second mode from an output voltage with respect to one input voltage to be inputted into said toner content detection sensor during execution of the operation in the second mode.

6. An apparatus according to claim 5, wherein the one input voltage to be inputted into said toner content detection sensor is changed depending on an elapsed time of use of the developer.
